(19) United States
(12) Patent Application Publication
(10) Pub. No.: US 2012/0011476 A1
(43) Pub. Date: Jan. 12, 2012

(54) ELECTRONIC DEVICE AND METHOD FOR SEARCHING MULTIMEDIA FILE

(75) Inventor: WEN-CHIN OU, Tu-Cheng (TW)

(73) Assignee: HON HAI PRECISION INDUSTRY CO., LTD., Tu-Cheng (TW)

(21) Appl. No.: 12/977,077

(22) Filed: Dec. 23, 2010

(30) Foreign Application Priority Data
Jul. 7, 2010 (CN) 201010219822.0

(51) Int. Cl. G06F 3/01

(52) U.S. Cl. 715/863

(57) ABSTRACT

An electronic device includes a touch screen, a memory module, a dividing module, an identifying module, a sorting module, and a driving module. The memory module saves multimedia files (MFs). Each MF has four tags, each tag corresponds to a category. The dividing module drives the touch screen to display areas that makes up a grid. The grid has reference lines: a horizontal line, a vertical line, a first diagonal line, and a second diagonal line. The identifying module identifies a vector of a user's slide on the touch screen that is substantially parallel to a reference line. The sorting module receives the vector identified by the identifying module and generates a list making up of the tags of the same category that corresponds to the vector. The driving module reads the list and drives the areas corresponding to the vector to display the tags of the list.

### BACKGROUND

1. Technical Field

The present disclosure relates to electronic devices and, particularly, to an electronic device and a method for searching a desired multimedia file.

2. Description of Related Art

Electronic devices, such as MP4s and mobile phones, are generally capable of displaying multimedia data, such as songs and images. When a number of multimedia files are saved in an electronic device, the names of the multimedia files make up a list. To select a desired multimedia file, users need to search through the potentially long list, which is quite inconvenient.

Therefore, it is desirable to provide an electronic device and a method for searching for a desired multimedia file, which can overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure.

FIG. 1 is a block diagram of an electronic device, according to an exemplary embodiment.

FIG. 2 is a diagram showing a multimedia file with four tags saved in the electronic device of FIG. 1.

FIG. 3 is an illustration of a touch screen of the electronic device of FIG. 1, the touch screen being divided into nine areas.

FIG. 4 shows four lists generated by a sorting module of the electronic device of FIG. 1, each list corresponding to a corresponding category of the multimedia files stored in the electronic device.

FIGS. 5A-5C show different views of the touch screen of the electronic device of FIG. 1 when users' finger slides along the left-right direction on the touch screen.

FIGS. 6A-6C show different views of the touch screen of the electronic device of FIG. 1 when users' finger slides along the top-bottom direction on the touch screen.

FIGS. 7A-7C show different views of the touch screen of the electronic device of FIG. 1 when users' finger slides along the upper left-lower right direction on the touch screen.

FIGS. 8A-8C show different views of the touch screen of the electronic device of FIG. 1 when users' finger slides along the upper right-lower left direction on the touch screen.

FIG. 9 is a diagram showing a deformation of the touch screen of FIG. 3.

FIGS. 10A-10B are diagram showing different views of the touch screen of the electronic device of FIG. 1 according to another embodiment.

FIG. 11 is a flowchart showing a method for searching multimedia files of the electronic device of FIG. 1, according to an exemplary embodiment.

### DETAILED DESCRIPTION

Embodiments of the present disclosure will now be described in detail with reference to the drawings.

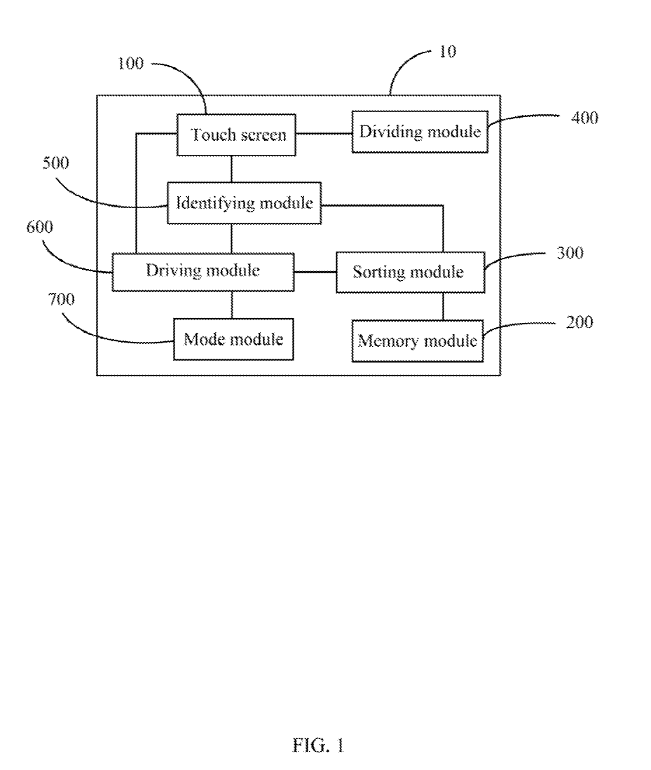

Referring to FIG. 1, an electronic device 10, according to an exemplary embodiment, includes a touch screen 100, a memory module 200, a sorting module 300, a dividing module 400, an identifying module 500, and a driving module 600.

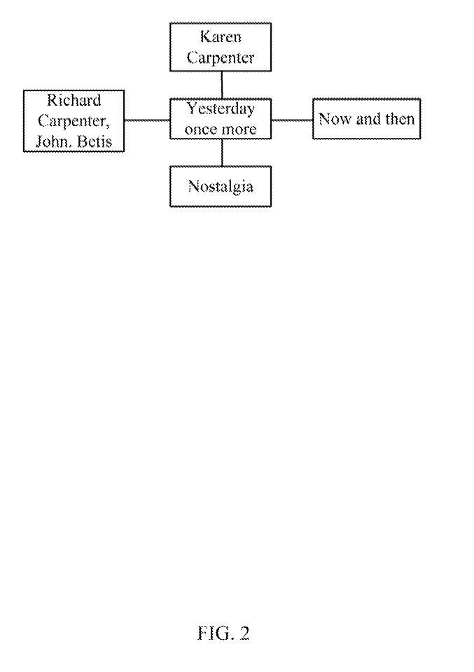

Referring to FIGS. 1 and 2, the memory module 200 is used for saving a number of multimedia files (MFs). Each MF has four tags. Each tag corresponds to a respective category. Therefore, the MF could be classified into four categories. For example, a MF is the song “yesterday once more”, then, it has four tags: “Karen Carpenter”, “Now and Then”, “Richard Carpenter, John. Betis”, and “Nostalgia”, corresponding to the following four respective categories: singer category, album category, composer category, and genre.

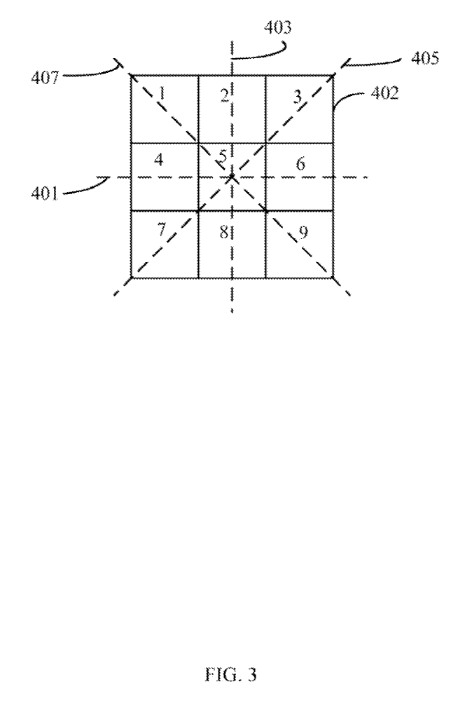

The dividing module 400 is connected to the touch screen 100 and configured for driving the touch screen 100 to display a number of areas that make up a grid. For example, Also referring to FIG. 3, the dividing module 400 drives the screen 100 to display areas 1˜9. The areas 1˜9 make up a grid 402. The grid 402 defines four reference lines: a horizontal line 401, a vertical line 403, a first diagonal line 405, and a second diagonal line 407.

The identifying module 500 is connected to the touch screen 100 and used for identifying a vector of a track of a user's slides on the touch screen 100, which is substantially parallel to the reference lines of the grid 402. For example, when a user's finger slides from the left to the right on the touch screen 100, the identifying module 500 identifies that the vector is from left to right, substantially parallel to the horizontal line 401. In the present embodiment, the vector also could be from right to left, from top to bottom, from bottom to top, from upper left to lower right, from lower right to upper left, from lower left to upper right, or from upper right to lower left. Two vectors that are substantially parallel to one of the reference lines of the grid 402 trigger the sorting of the same category of the MF (described in detail below) and the displaying of the areas corresponding to the vector (described in detail below).

The sorting module 300 is connected to the identifying module 500 and the memory module 200. The sorting module 300 is used to receive the vector generated by the identifying module 500 and generate a list making up of the tags of the same category that corresponds to the vector. For example, when receiving a vector that is from left to right, the sorting module 300 will be triggered by the vector to collect the tags respecting to the singer category and combines the tags into a singer list. The tags could be arranged in accordance with the ascending or descending sequence of the letter of the tag.

The driving module 600 is connected to the identifying module 500, the sorting module 300, and the touch screen 100. The driving module 600 is configured for receiving the vector generated by the identifying module 500, reading the list generated by the sorting module 300, and driving areas corresponding to the vector to display tags of the list. The driving module 600 is also configured for driving the areas to scroll the tags of the list when receiving a vector on the same direction as the previous vector or opposite to the previous vector.

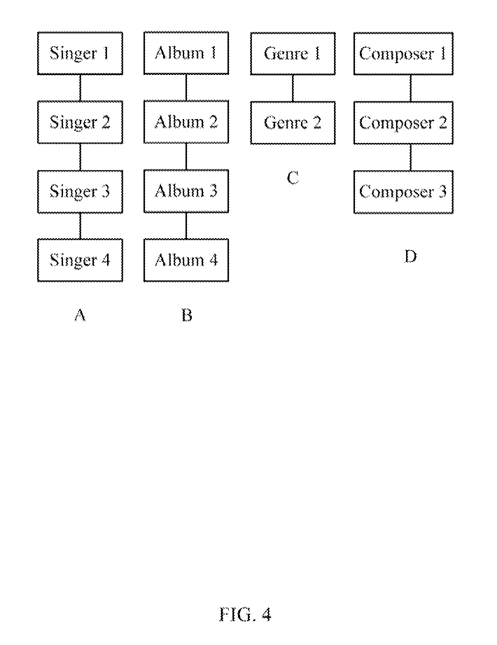

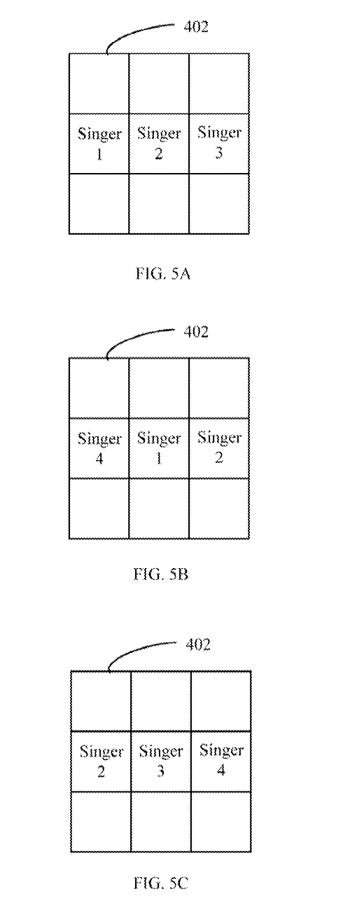

For example, referring to FIG. 4 and FIGS. 5A to 5C, when a user's finger slides from left to right on the touch screen 100, the identifying module 500 identifies that the vector is from left to right. Triggered by the vector, the sorting module 300 combines the tags respecting to, for example, the singer category into a singer list A (shown in FIG. 4). The dividing module 400 drives the touch screen 100 to display nine areas 1˜9 that make up the grid 402. The driving module 600 then reads the singer list A generated by the sorting module 300, drives the areas 4, 5, 6 corresponding to the vector to display tags of the singer list A (shown in FIG. 5A).

Further, when the user's finger slides from left to right on the touch screen 100 again, the driving module 600 drives the areas 4, 5, 6 to scroll up the tags of the singer list A (shown in FIG. 5B). As shown in the FIG. 5B, the singer list A can be rotated in a circle. Or, when the slide is from right to left, the driving module 600 drives the areas 4, 5, 6 to scroll down the tags of the singer list A (shown in FIG. 5C).

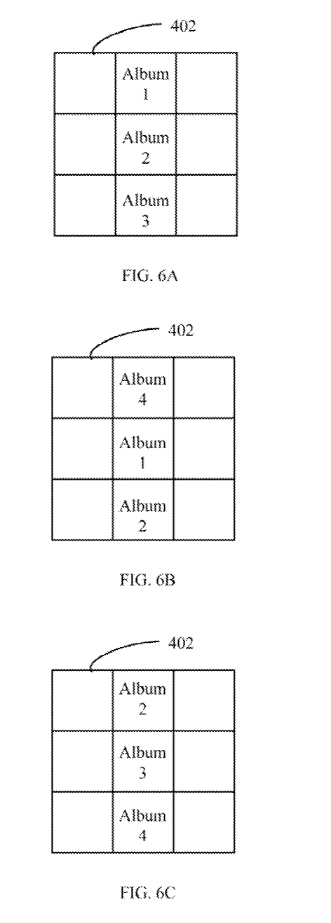

Referring to FIG. 4 and FIGS. 6A to 6C, when a user's finger slides from top to bottom on the touch screen 100, the identifying module 500 identifies that the vector is from top to bottom. Triggered by the vector, the sorting module 300 combines the tags respecting to, for example, the album category into an album list B (shown in FIG. 4). The dividing module 400 drives the touch screen 100 to display nine areas 1˜9 that make up the grid 402. The driving module 600 then reads the album list B generated by the sorting module 300, drives the areas 2, 5, 8 that corresponding to the vector to display the tags of album list B (shown in FIG. 6A)

Further, when the user's finger slides from top to bottom on the touch screen 100 again, the driving module 600 drives the areas 2, 5, 8 to scroll up the tags of the album list B (shown in FIG. 6B). As shown in the FIG. 6B, the album list B can be rotated in a circle. Or, when the vector is from bottom to top, the driving module 600 drives the areas 2 5, 8 to scroll down the tags of the album list B (shown in FIG. 6C).

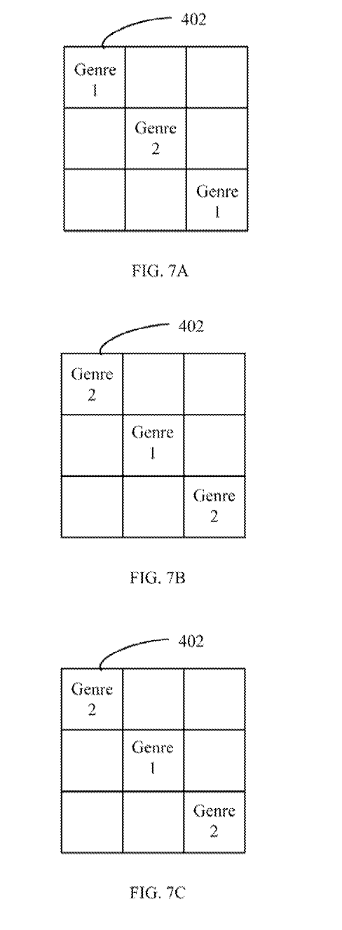

Referring to FIG. 4 and FIGS. 7A to 7C, when a user's finger slides from upper left to lower right on the touch screen 100, the identifying module 500 identifies that the vector is from upper left to lower right. Triggered by the vector, the sorting module 300 combines the tags respecting to, for example, the genre into a genre list C (shown in FIG. 4). The dividing module 400 drives the touch screen 100 to display nine areas 1˜9 that make up the grid 402. The driving module 600 reads the genre list C generated by the sorting module 300, drives the areas 1, 5, 9 that corresponding to the vector to display tags of the genre list C (shown in FIG. 7A).

Further, when the user's finger slides from upper left to lower right on the touch screen 100 again, the driving module 600 drives the areas 1, 5, 9 to scroll up the tags of the genre list C (shown in FIG. 7B). As shown in the FIG. 7B, the genre list C can be rotated in a circle. Or, when the vector is from lower right to upper left, the driving module 600 drives the areas 1, 5, 9 to scroll down the tags of the genre list C (shown in FIG. 7C).

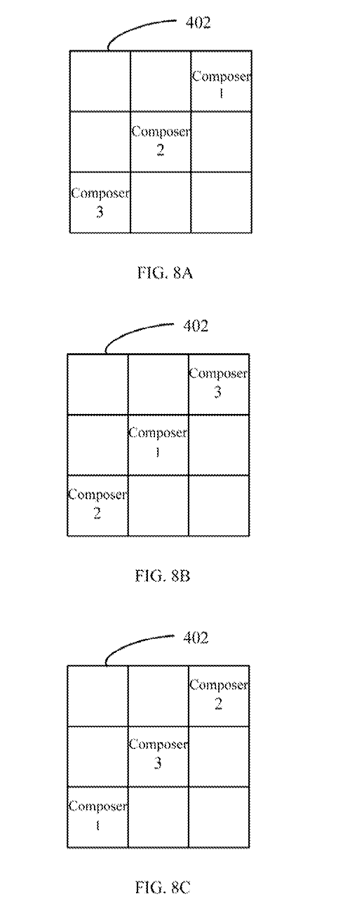

Referring to FIG. 4 and FIGS. 8A to 8C, when a user's finger slides from upper right to lower left on the touch screen 100, the identifying module 500 identifies that the vector is from upper right to lower left. Triggered by the vector, the sorting module 300 combines the tags respecting to, for example, the composer category into a composer list D (shown in FIG. 4). The dividing module 400 drives the touch screen 100 to display nine areas 1˜9 that make up the grid 402. The driving module 600 reads the composer list D generated by the sorting module 300, drives the areas 3, 5, 7 that corresponding to the vector to display tags of the composer list D (shown in FIG. 8A).

Further, when the user's finger slides from upper right to lower left on the touch screen 100 again, the driving module 600 drives the areas 3, 5, 7 to scroll up the tags of the composer list D (shown in FIG. 8B). As shown in the FIG. 8B, the composer list D can be rotated in a circle. Or, when the vector is from lower left to upper right, the driving module 600 drives the areas 3, 5, 7 to scroll down the tags of the composer list D (shown in FIG. 8C).

In the present disclosure, users could select the desired MF through the singer, album, composer, or genre categories, which can be generated after a corresponding sliding on the touch screen 100, rather than directly select from a long list making up of the names of the MF. Therefore, it's convenient for the users to make selections.

It should be understood that, in alternative embodiments, the categories could be other items, not limited to the present embodiment. Meanwhile, the pattern that the vectors correspond to the categories is not limited at the present embodiment. For example, when the vector is from left to right, the driving module 600 may drive the areas 4, 5, 6 to scroll up the tags of an album list B.

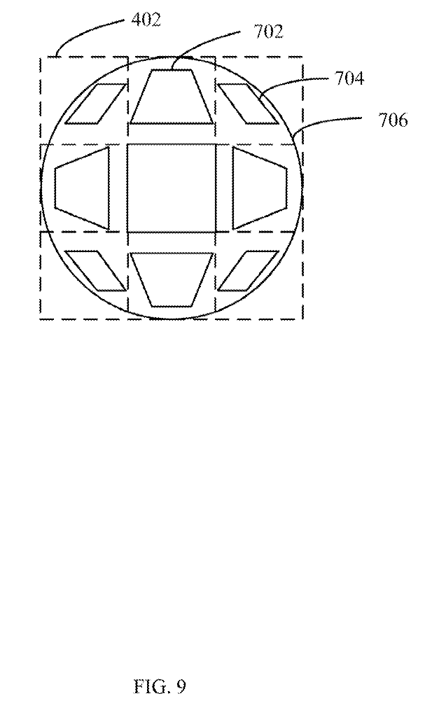

Referring to FIGS. 1 and 9, in alternative embodiments, the electronic device 10 may further include a mode module 700 connected to the driving module 600. The mode module 700 is configured to deform the areas. In the present embodiment, the mode module 700 drives the areas 1, 2, 3, 4, 6, 7, 8, and 9 that surround the area 5 at the center of the grid 402 to display an inscribed circle 706 of the grid 402. The mode module 700 also drives the displays at the areas 1, 2, 3, 4, 6, 7, 8, and 9 to deform between the circle 706 and the area 5 at the center of the grid 402.

In detail, the mode module 700 drives the displays in the areas 2, 8, 4, and 6 that respectively at the top, bottom, left, and right sides of the area 5 to deform into isosceles trapeziums 702, with the longer base adjacent to the area 5. The mode module 700 drives the displays in the areas 1, 3, 9, and 7 at the corner of the grid 402 to deform into parallelograms 704. When a tag displayed at the areas 1 to 4 or 6 to 9 scrolls into the area 5, the tag is displayed normally in it. When the tag scrolls out of the area 5, it is distortedly displayed again.

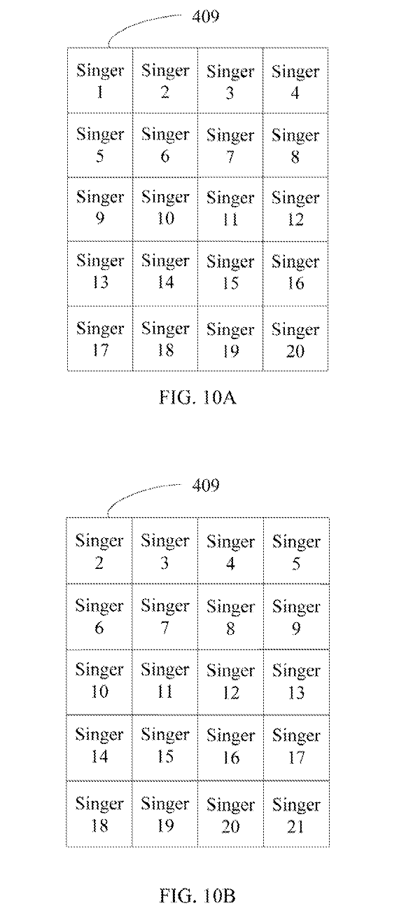

In alternative embodiments, the dividing module 400 can also drives the touch screen 100 to display more than or less than 9 areas that also makes up a grid. For example, referring to FIG. 10A, the dividing module 400 drives the touch screen 100 to display 20 areas that make up a grid 409.

In alternative embodiments, the driving module 600 can drive all areas to display tags of a list. For example, referring to FIGS. 10A and 10B, when a user's finger slides from right to left on the touch screen 100, the driving module 600 drives all the areas of the grid 409 to display a singer list. After that, when the user's finger slides from right to left on the touch screen 100 again, the driving module 600 drives all the areas to scroll down the tags of the singer list (shown in FIG. 10B).

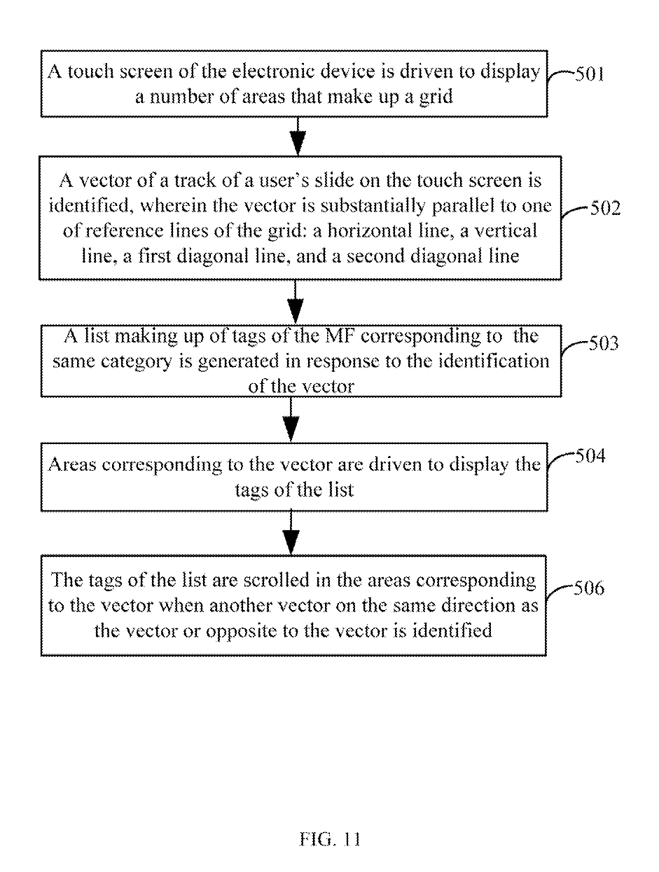

Referring to FIG. 11, a method for searching for a MF of an electronic device wherein the MF has four tags that each corresponding to a respective category, according to an exemplary embodiment, includes the following steps.

In step 501, a touch screen of the electronic device is driven to display a number of areas that make up a grid.

In step 502, a vector of a track of a user's slide on the touch screen is identified, wherein the vector is substantially parallel to one of reference lines of the grid: a horizontal line, a vertical line, a first diagonal line, and a second diagonal line.

In step 503, a list making up of tags of the MF of the same category is generated in response to the identification of the vector. In one embodiment, a singer list making up of tags corresponding to a singer category is generated when the vector is from left to right, or from right to left. An album list making up of tags corresponding to an album category is generated when the vector is from top to bottom or from bottom to top. A genre list making up of tags corresponding to a genre category is generated when the vector is from upper left to lower right, or from lower right to upper left. A composer list making up of tags corresponding to a composer category is generated when the vector is from upper right to lower left, or from lower left to upper right.

In step 504, areas corresponding to the vector are driven to display the tags of the list. For example, the areas corresponding to the vector are driven to display the tags of the singer list when the vector is from left to right or from right to left.

In step 506, the tags of the list are scrolled in the areas corresponding to the vector when another vector on the same direction as the vector or opposite to the vector is identified.

It will be understood that the above particular embodiments is shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. An electronic device, comprising:
a touch screen;
a memory module configured for saving a plurality of multimedia files (MFs), wherein each MF has four tags, each tag corresponds to a respective category;
a dividing module connected to the touch screen and configured for driving the touch screen to display a plurality of areas that make up a grid, the grid having reference lines: a horizontal line, a vertical line, a first diagonal line, and a second diagonal line;
an identifying module connected to the touch screen and configured for identifying a first vector of a track of a user's slide on the touch screen, wherein the first vector is substantially parallel to one of the reference lines of the grid;
an sorting module connected to the identifying module and the memory module, and configured for receiving the first vector identified by the identifying module and generating a list making up of the tags of the same category that corresponds to the first vector; and
a driving module connected to the identifying module, the sorting module, and the touch screen, and configured for receiving the first vector identified by the identifying module, reading the list generated by the sorting module, and driving the areas corresponding to the first vector to display the tags of the list.

2. The electronic device of claim 1, wherein the first vector is selected from the group consisting of: from left to right, from right to left, from top to bottom, from bottom to top, from upper left to lower right, from lower right to upper left, from lower left to upper right, and from upper right to lower left.

3. The electronic device of claim 2, wherein when the identifying module identifies that the first vector is from left to right or from right to left, the sorting module generates a first list making up of tags corresponding to a first category; when the identifying module identifies that the first vector is from top to bottom, or from bottom to top, the sorting module generates a second list making up of tags corresponding to a second category; when the identifying module identifies that the first vector is from upper left to lower right, or from lower right to upper left, the sorting module generates a third list making up of tags corresponding to a third category; when the identifying module identifies that the first vector is from upper right to lower left, or from lower left to upper right, the sorting module generates a fourth list making up of tags corresponding to a fourth category.

4. The electronic device of claim 3, wherein the dividing module drives the touch screen to display no less than 9 areas that make up a grid, the rows of the grid are the same as the columns of the grid; when the identifying module identifies a second vector that is from left to right or from right to left, the driving module respectively drives the areas along a middle row of the grid to scroll the tags of the first list right or left; when the identifying module identifies the second vector that is from top to bottom or from bottom to top, the driving module respectively drives the areas along a middle column of the grid to scroll down or scroll up the tags of the second list; when the identifying module identifies the second vector that is from upper left to lower right or from lower right to upper left, the driving module respectively drives the areas along the first diagonal of the grid to scroll the tags of the third list along the first diagonal of the grid; when the identifying module identifies the second vector is from upper right to lower left or from lower left to upper right, the driving module respectively drives the areas at the second diagonal of the grid to scroll the tags of the fourth list along the second diagonal.

5. The electronic device of claim 1, wherein when the identifying module identifies a second vector that is in the same direction as the first vector or opposite to the first vector, the driving module drives the areas corresponding to the first vector to scroll the tags of the list.

6. The electronic device of claim 1, wherein all the areas of the grid correspond to the first vector.

7. The electronic device of claim 1, further comprising a mode module connected to the driving module, wherein the mode module is configured to deform some of the areas.

8. The electronic device of claim 7, wherein the mode module drives the areas surrounding the area at the center of the grid to display an inscribed circle of the grid, and also drives the displays at the areas surrounding the area at the center of the grid to deform between the inscribed circle and the area at the center of the grid.

9. The electronic device of claim 8, wherein the mode module drives the displays in the areas that locate respectively at the top, bottom, left, and right sides of the area at the center of the grid to deform into isosceles trapeziums, with the longer base adjacent to the area at the center of the grid, and drives the displays in the areas at the four corners of the grid to deform into parallelograms.

10. The electronic device of claim 1, wherein the sorting module arranges the tags in the list in accordance with the ascending or descending sequence of the letter of the tag.

11. The electronic device of claim 1, wherein the categories of each MF comprise a singer category, an album category, a composer category, and a genre category.

12. A method for searching MFs stored in an electronic device, each MF having four tags, each of which corresponds to a respective category, the method comprising:
driving a touch screen of the electronic device to display a number of areas that make up a grid, wherein the gird has reference lines: a horizontal line, a vertical line, a first diagonal line, and a second diagonal line;
identifying a first vector of a track of a user's slide on the touch screen, wherein the first vector is substantially parallel to one of the reference lines of the grid;
generating a list making up of the tags of the same category in response to the identification of the first vector;
driving the areas corresponding to the first vector to display the tags of the list; and
scrolling the tags of the list in the areas corresponding to the first vector when a second vector in the same direction as the first vector or opposite to the first vector is identified.

13. The method of claim 12, wherein in the step of generating a list making up of the tags of the same category in response to the identification of the first vector, when the first vector is substantially parallel to the horizontal line, a singer list making up of the tags corresponding to a singer category is generated; when the first vector is substantially parallel to the vertical line, an album list making up of the tags corresponding to an album category is generated; when the first vector is substantially parallel to the first diagonal line, a genre list making up of the tags corresponding to a genre category is generated; when the first vector is substantially parallel to the second diagonal line, a composer list making up of the tags corresponding to a composer category is generated.

14. The method of claim 12, wherein the categories of each MF comprise a singer category, an album category, a composer category, and a genre category.
